(19) United States
(12) Patent Application Publication
(10) Pub. No.: US 2018/0007133 A1
(43) Pub. Date: Jan. 4, 2018

(54) SERVER-TO-SERVER CONTENT DISTRIBUTION

(71) Applicant: Microsoft Technology Licensing, LLC., Redmond, WA (US)

(72) Inventors: Fanguang Kong, Sammamish, WA (US); Vasilios Petrakos, Bellevue, WA (US); Yu Ukai, Kawasaki-shi (JP); Yasuhiko Mori, Tokyo (JP); Yasufumi Shiraishi, Tokoyo (JP); Ginger Fang, Bellevue, WA (US); Han Jung, Sammamish, WA (US); Jin Wang, Kirkland, WA (US); Amol Anant Natu, Duvall, WA (US); Suleiman Jabbouri, Redmond, WA (US); Gareth Alun Jones, Snoqualmie, WA (US); Jay Ongg, Renton, WA (US); Darren Austin, Seattle, WA (US); Xing Fan, Tokyo (JP); Brian Hardy, Duvall, WA (US)

(73) Assignee: Microsoft Technology Licensing, LLC., Redmond, WA (US)

(21) Appl. No.: 15/199,500

(22) Filed: Jun. 30, 2016

(51) Int. Cl. H04L 29/08; H04L 29/06

(52) U.S. Cl. CPC H04L 67/1095; H04L 67/42; H04L 67/02; H04L 67/2842

(57) ABSTRACT

A non-limiting example method includes receiving a request to publish content that is stored on a user storage server in a personal data store. The method includes preparing the content for publication and moving the prepared content to a content repository to generate published content. The method includes receiving a request to make a personal copy of the published content and making a copy of the published content in a personal data store in a user storage server. The copy is independently editable of the published content. A non-limiting example system includes an application programming interface that includes a publish command to generate a published copy of a specified first content stored in a first personal data store in a content repository, and a retrieve command that generates a personal copy of a specified second content stored in the content repository in a second personal data store.

### BACKGROUND

Content may be stored in the “cloud,” which means the content is available on network-based storage server that is accessible over a network such as the Internet. A single user or multiple users may be able to access and edit the content in the cloud. Often, a user will have a personal data store in the cloud that can be used to store various files and content that the user controls. The personal data store may be private to the user or limited to a group of other users. Sometimes, an agent will run on a user's computing device to synchronize the content in the personal data store with the computing device. For example, if content is modified on the computing device, the modifications are also made to content in the personal data store.

Sometimes users interact with multiple cloud-based data stores. If a user wants to add existing content from a cloud-base data store to a personal data store, the user will typically need to download the content to a local computing device and then transfer the content to the personal data store. This process can be error prone, time consuming, and difficult—or even impossible if using a mobile device or public computer terminal.

It is with respect to these and other general considerations that aspects have been made. Also, although relatively specific problems have been discussed, it should be understood that the aspects should not be limited to solving the specific problems identified in the background.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

A first aspect is a method for server-to-server content distribution. The method includes receiving a publish request to publish content that is stored on a user storage server in a personal data store. The method also includes preparing the content for publication and moving the prepared content to a content repository to generate published content. The method also includes receiving a request to make a personal copy of the published content and making a copy of the published content in a personal data store in a user storage server. The copy is independently editable of the published content.

Another aspect is a system for server-to-server content distribution. The system includes a processor and memory storing instructions for an application programming interface that includes a publish command and retrieve command. The publish command generates a published copy of a specified first content stored in a first personal data store in a content repository. The retrieve command causes generates a personal copy of a specified second content stored in the content repository in a second personal data store.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

Non-limiting and non-exhaustive examples are described with reference to the following figures.

FIG. 1 is a simplified block diagram of one example of a system for server-to-server content distribution.

FIG. 2 illustrates a method for performing server-to-server content distribution.

FIG. 3 illustrates an embodiment of a distribution engine.

FIG. 4 illustrates a method for publishing content for server-to-server content distribution.

FIG. 5 illustrates a method for making a personal copy of published content.

FIG. 6 is a block diagram illustrating example physical components of a computing device.

FIGS. 7A and 7B are block diagrams of a mobile computing device.

FIG. 8 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

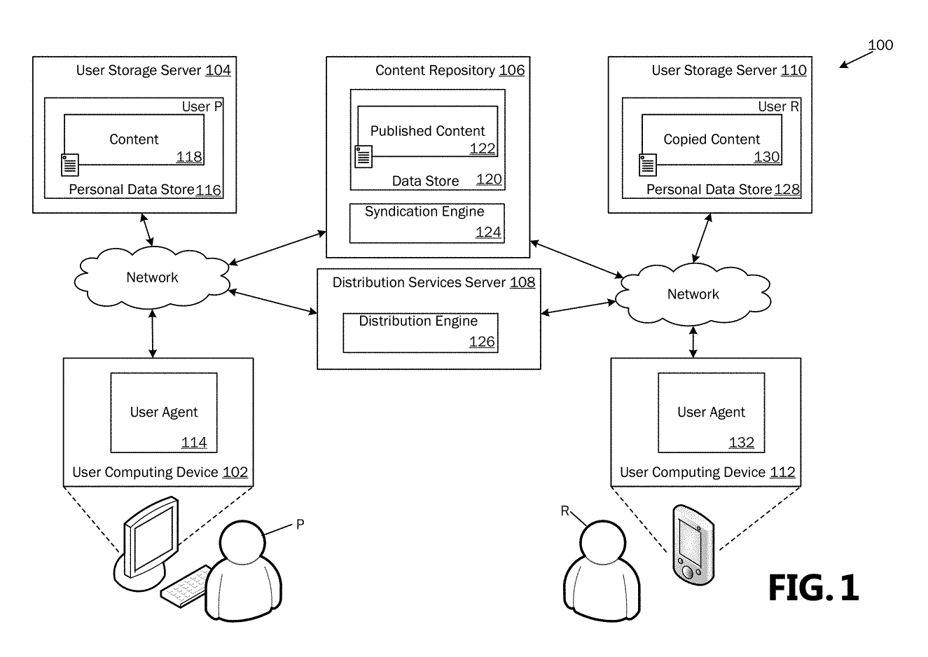

FIG. 1 is a simplified block diagram of one example of a system 100 for server-to-server content distribution. As illustrated in FIG. 1, the system 100 includes a first user computing device 102 that is operable by a publisher user P, a first user storage server 104, a content repository 106, a distribution services server 108, a second user storage server 110, and a second user computing device 112 that is operable by a recipient user R. The first user computing device 102, the first user storage server 104, the content repository 106, the distribution services server 108, the second user storage server 110, and the second user computing device 112 communicate over one or more networks.

The first user computing device 102 includes a user agent 114. The user agent 114 allows the user to interact with content, such as content 118 stored in personal data store 116 on the first user storage server 104. In some embodiments, the user agent 114 is an application running on the first user computing device 102 that interacts with one or both of the first user storage server 104 and the distribution services server 108. Examples of the user agent 114 include the ONENOTE notes management application, the WORD document authoring tool, the EXCEL® spreadsheet authoring tool, and the POWERPOINT® presentation authoring tool all from Microsoft Corporation of Redmond, Wash. Other examples of the user agent include the KEEP notes management application from Google Inc. of Mountain View, Calif., the EVERNOTE notes management application from Evernote Corporation if Redwood City, Calif., and the APPLE NOTES notes management application from Apple Inc. of Cupertino, Calif.

Additionally, the user agent 114 may be a component of an operating system running on the first user computing device 102. In some examples, the user agent 114 is a browser application operable to generate interactive graphical user interfaces based on content served by the first user storage server 104 or another remote computing device. According to an example, an extension is installed on the first user computing device 102 as a plug-in or add-on to the browser application (i.e., the user agent 114) or is embedded in the browser application.

The first user storage server 104 operates to store content for users. In some embodiments, the first user storage server 104 operates to store content for multiple users. The first user storage server 104 may include at least one personal data store 116, each of which may be associated with at least one particular user. In some aspects, the personal data store 116 is associated with a group of users such as the members of a team, department, or organization.

As illustrated in FIG. 1, the first user storage server 104 includes a personal data store 116 associated with the publisher user P. Examples of the first user storage server 104 may include any number of personal data stores. In some aspects, the first user storage server 104 is configured to limit access to the personal data store 116 and the content stored therein to an associated user. In some embodiments, a user may be able to permit other users to access at least some of the files in the personal data store.

In some embodiments, the first user storage server 104 is provided by a network-based storage server (e.g., a cloud storage server) such as OneDrive from Microsoft Corporation of Redmond, Wash., Google Drive from Google Inc. of Mountain View, Calif., Box from Box Inc. of Los Altos, Calif., Dropbox from DropBox, Inc. of San Francisco, Calif., Syncplicity from Syncplicity LLC of Santa Clara, Calif., and other network-based storage or file sharing services.

In the example shown in FIG. 1, the personal data store 116 associated with the publisher user P stores the content 118. The personal data store 116 operates to store files and other data and may comprise one or more file systems and databases such as relational databases. The personal data store 116 may comprise one or more server computing devices. In some aspects, the personal data store 116 may comprise a distributed database or a distributed file system.

The content 118 may have been generated or edited by the publisher user P using the user agent 114. In some aspects, the content 118 is stored in one or more files. The content 118 may include various types of metadata, including, but not limited to, previous versions of the content 118, version history information, editorial markup of the content 118, and information about the authors of the content 118. Some examples of the content 118 are a travel guide notebook or a curriculum guide notebook.

The content repository 106 stores published content 122 for distribution to an audience. The content repository 106 includes a data store 120. The data store 120 may be provided by a network-based storage server. The data store 120 may be similar to the previously described personal data store 116 except that the data store 120 is not necessarily associated with a particular user.

The content repository 106 may also comprise a web site such as Docs.com from Microsoft Corporation of Redmond, Wash., that operates to store or distribute the published content 122. The content repository may include a syndication engine 124 that operates to allow other sites and services to access, embed, preview, or share the published content 122. For example, the syndication engine 124 may share the published content 122 via blogs, social media services, or RSS feeds. In some aspects, the content that is shared by the syndication engine 124 includes a link through which a user can make a personal copy of the content.

The distribution services server 108 operates to publish content and make copies of published content in personal data stores. The distribution services server 108 may include a distribution engine 126 that performs server-to-server publishing and server-to-server copying. The distribution services server 108 may be configured to interact with a plurality of user storage servers such as the first user storage server 104 and the second user storage server 110 and a plurality of content repositories such as the content repository 106. In addition, the distribution services server 108 may receive requests directly from user computing devices such as the first user computing device 102 and the second user computing device 112. Alternatively, requests may be received from the user storage servers or elsewhere. In the example shown in FIG. 1, the published content 122 was published from the content 118 by the distribution services server 108 based on a request from the first user computing device 102.

The second user storage server 110 may be similar to the first user storage server 104. In the example shown in FIG. 1, the second user storage server 110 includes a personal data store 128 that is associated with the recipient user R. The personal data store 128 may be similar to the previously described personal data store 116. The personal data store 128 is shown as storing copied content 130. In this example, the copied content 130 was copied from the published content 122 by the distribution engine 126 based on a request from the second user computing device 112. In this manner, the recipient user R now has a personal copy of the published content 122, which can be used for note taking, editing, or other activities.

Although FIG. 1 shows the first user storage server 104 and the second user storage server 110 as being separate, in some aspects, the first user storage server 104 and the second user storage server 110 comprise the same servers. Alternatively, the first user storage server 104 and the second user storage server 110 may be provided by different types of network-based storage servers. For example, the first user storage server 104 may be a ONEDRIVE® storage server and the second user storage server 110 may be a DROPBOX storage server.

The second user computing device 112 may be similar to the first user computing device 102 and includes a user agent 132 that may be similar to the user agent 114. Additionally, the second user computing device 112 may be used for both publishing content and receiving content. For example, the recipient user R may edit the copied content 130 using the user agent 132 and then publish the edited content back to the content repository 106 as new published content.

Although FIG. 1 shows the content repository 106 and the distribution services server 108 as separate servers, in some aspects, the content repository 106 and the distribution services server 108 are the same server. Further, as used herein a server may comprise one or more computing devices, including one or more server farms, which may be located anywhere or distributed in various locations throughout the world. In some aspects, the user agent 114 includes the publish functionality.

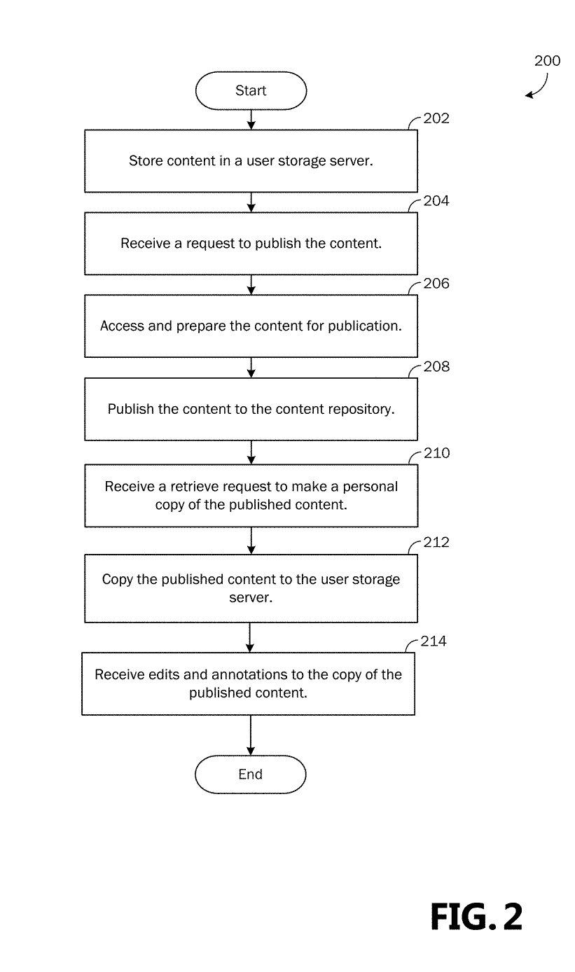

FIG. 2 illustrates a method 200 for performing server-to-server content distribution. As an example, the method 200 may be executed by a component of an exemplary system such as the system 100. In examples, the method 200 may be executed on one or more devices comprising at least one processor configured to store and execute operations, programs, or instructions.

At operation 202, content is stored in a network-based storage location such as the first user storage server 104. For example, the content may be generated by the publisher user P using the user agent 114 on the first user computing device 102.

At operation 204, a request is received to publish the content. The request may be received at the distribution services server 108 through a call to an application programming interface provided by the distribution engine 126. As an example, the request may be generated by the user agent 114 and transmitted by the first user computing device 102 to the distribution services server 108. Alternatively, the request may be generated and transmitted by the first user storage server 104 (e.g., a file browser on the first user storage server 104 may include a publish option). As yet another alternative, the request may be generated and transmitted by the content repository 106 (e.g., based on information provided by a user to identify content stored on a user storage server). In some aspects, the request identifies the content to publish, the first user storage server 104, and the content repository 106. Additionally, the request may include one or more authentication credentials (e.g., user name and password or certificate) that are usable to access the personal data store 116 and to publish content to the content repository 106. Alternatively, the distribution engine 126 may cache authentication credentials for users to access various user storage servers or content repository. In this case, the distribution engine 126 may authenticate the user and then may access the cached authentication credentials associated with the user as needed to access various other servers.

At operation 206, the distribution engine 126 accesses content (e.g., the content 118 in the example of FIG. 1) on the first user storage server 104. In some aspects, the distribution engine 126 uses authentication credentials that were received with the publication request. Additionally, the distribution engine 126 may prepare the content for publication by, for example removing file history, change markup, and author metadata from the content. The distribution engine 126 may also combine multiple files if the content spans multiple files. Further, the distribution engine 126 may also compress the file or group of files associated with the content to simplify transferring the content to the content repository 106. The distribution engine 126 may create a temporary local copy of the content on the distribution services server 108 upon which the steps necessary to prepare the content are performed. Alternatively, the distribution engine 126 may make a temporary copy of the content on the first user storage server 104 or request that the first user storage server 104 prepare the content for publication.

At operation 208, the content is published to the content repository 106. To publish the content, the distribution engine 126 may transmit the prepared copy of the content to the content repository 106 for storage. The distribution engine 126 may use authentication credentials that were received with the request to publish the content to access the content repository 106. The distribution engine 126 may also transmit information about the content to the content repository 106 such as one or more of the author, title, and description of the content.

Upon receiving the content, the content repository 106 may store the content in a database or file system. In some aspects, the content is stored in a packaged or compressed format in the content repository 106 (e.g., as a zip file). Alternatively, the content may be decompressed or extracted from a package before being stored. Additionally, the content repository 106 will make the content available to the public (or a subset thereof). For example, the content may be listed in a directory where users can access the content on the public content repository. The syndication engine 124 may also add the content to an RSS feed, blog, or social media site.

At operation 210, a retrieve request to make a personal copy of the published copy is received. For example, the request may be received by the distribution services server 108 from the second user computing device 112. Alternatively, the request may be received from the content repository 106 based on the user clicking a link or activating another user interface element generated by the content repository 106 or the syndication engine 124. The request may include various information such as an identifier of the published content, an identifier of the content repository (e.g., an Internet Protocol (IP) address or a universal resource locator (URL)), and an identifier of the second user storage server 110. The request may also include authentication credentials to access the content repository 106 and the second user storage server 110.

At operation 212, the published content is copied to the user storage server. For example, the published content 122 may be copied from the content repository 106 to the personal data store 128 on the second user storage server 110. In some aspects, the published content 122 a packaged or compressed version of the content is copied to the second user storage server 110. The packaged or compressed version of the published content 122 may be stored on the content repository 106. Otherwise, the distribution engine 126 may compress or package the published content 122 before transmitting the published content 122 to the second user storage server 110. After the published content 122 is copied into the personal data store 128, the distribution engine 126 may extract or otherwise unpack the copied content to that is usable. The distribution engine 126 may use authentication credentials received with the request to gain permission to copy the content into the personal data store 128. In some embodiments, the published content 122 is copied from the content repository 106 to the second user storage server 110 without passing through the second user computing device 112 (i.e., the copy is a server-to-server copy). Server-to-server copies may be particularly beneficial when the

At operation 214, edits and annotations are received to the copied content 130. For example, the recipient user R may use the user agent 132 to interact with the copied content 130 stored in the personal data store 128. The recipient user R may add notes to the copied content 130 that reflect personal experiences related to the copied content 130. The recipient user R may also use the user agent 132 to edit the copied content 130. Despite the user interacting with and modifying the copied content 130, the published content 122 is unaffected.

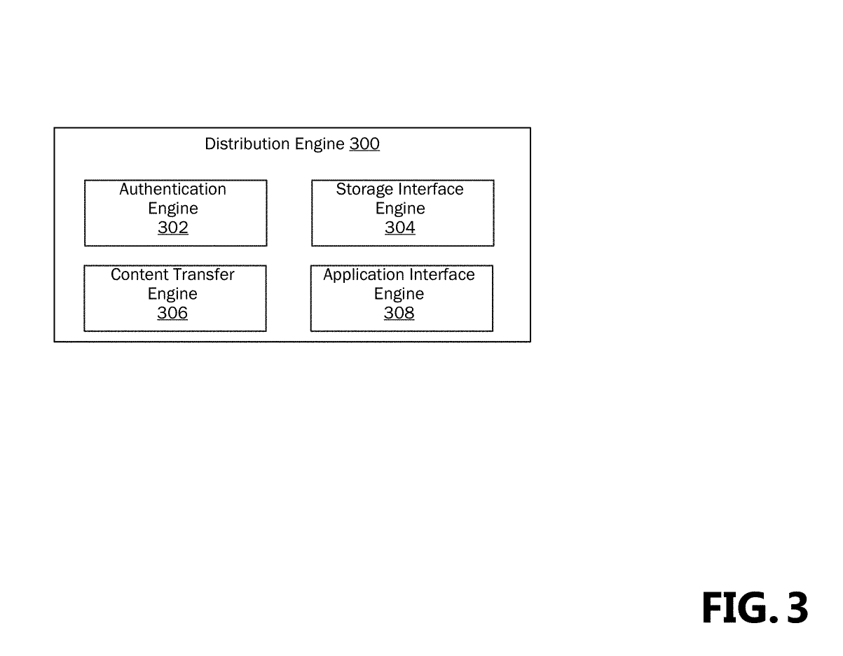

FIG. 3 illustrates an embodiment of a distribution engine 300. The distribution engine 300 is an example of a distribution engine such as the distribution engine 126 illustrated in FIG. 1. In some embodiments, the distribution engine 300 includes an authentication engine 302, a storage interface engine 304, a content transfer engine 306, and an application interface engine 308.

The authentication engine 302 manage authentication of users. In some aspects, the authentication engine 302 authenticates users who submit requests. For example, the authentication engine 302 may receive authentication credentials from users and use those authentication credentials to authenticate the users (e.g., by accessing an authentication server or evaluating the authentication credentials against locally stored authentication information).

The authentication engine 302 may also manage user authentication credentials to access one or more user storage servers and content repositories. In some aspects, the authentication engine 302 passes through authentication credentials that are received from a user to the appropriate external server (e.g., the user may provide a login and password for an account with a user storage server, and the authentication engine passes those credentials through to the user storage server to gain access to the user storage server).

Alternatively, the authentication engine 302 may maintain a cache of authentication credentials for a user. In these aspects, when a request is received from a user to access a particular user storage server or content repository, the authentication engine 302 retrieves the user's authentication credentials from the cache for use in gaining access to the user storage server or content repository.

The storage interface engine 304 communicates with the user storage servers and content repositories. The storage interface engine 304 may communicate with multiple different types of user storage servers and content repositories that support different command structures (i.e., different application programming interfaces (APIs)). In some aspects, the storage interface engine 304 determines the appropriate application programming interface to use to communicate with a particular user storage server or content repository and then formats a command for the server accordingly. For example, the storage interface engine 304 may access a table that stores information each of the user storage servers and content repositories supported by the distribution engine 126. The table may store some or all of the following information: an address for accessing the server, authentication settings or procedures for the server, command format and required parameters to store content on the server, command format and required parameters to retrieve content from the server.

The content transfer engine 306 transfers content from one server to another (e.g., from a user storage server to a content repository or from a content repository to a user storage server). In some aspects, the content transfer engine 306 packages and or compresses content before it is transferred. In these embodiments, the content transfer engine 306 may also unpack or decompress content after a transfer.

The application interface engine 308 receives requests to distribute content. For example, the application interface engine 308 may expose an application programming interface (API) for making requests to publish content to a content repository or to make a personal copy of published content in a personal data store. The application interface engine 308 may be configured to receive these requests from user storage servers, content repositories, user agents, or elsewhere.

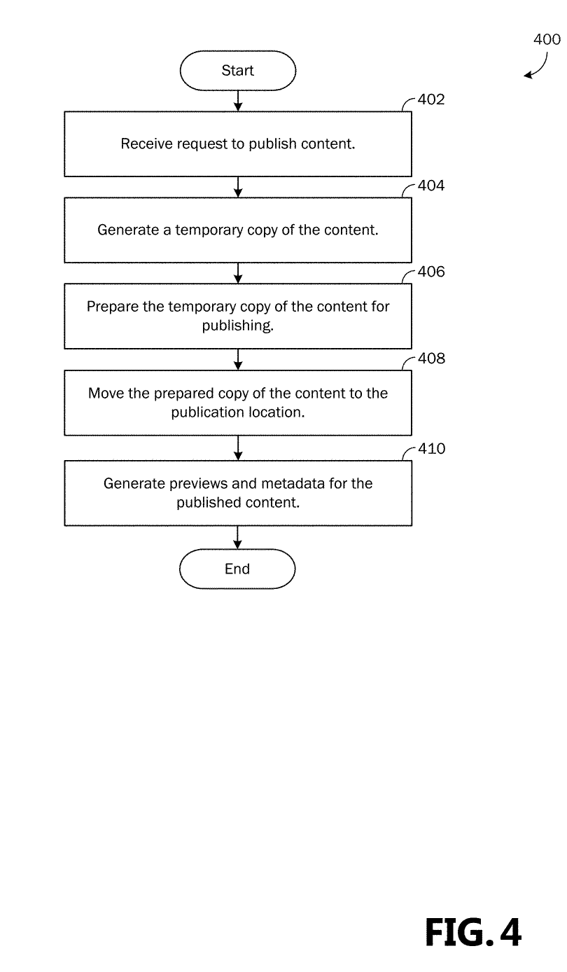

FIG. 4 illustrates a method 400 for publishing content for server-to-server content distribution. As an example, the method 400 may be executed by a component of an exemplary system such as the system 100. For example, the method 400 may be performed by the distribution engine 126. In examples, the method 400 may be executed on a device comprising at least one processor configured to store and execute operations, programs, or instructions.

At operation 402, a request to publish content is received. The operation 402 may be similar to the previously described operation 204.

In some aspects, the request is received through a user interface generated by a user storage system or user agent. For example, the request may be generated through a popup menu (or another user interface element) that is displayed when a user selects content in a list or browser used to view or interact with content on user storage server. The request may also be generated by the user agent with respect to content that is currently open (e.g., the user agent may include a menu option to publish content).

The user interface may then prompt the user to identify a content repository to which the content is to be published. The user interface may list various content repositories with which the user is known to be associated. In some aspects, the user may also enter information about a content repository that is not included in the list. The content repository may be wholly new to the system. Alternatively, the content repository may be known to the system, but not yet associated with the user. For example, the user may select the content repository from a list of content repositories that are known. The user may then be prompted to enter account credentials for the content repository. Thereafter, the user's association with the content repository may be stored so that the user can more quickly identify the content repository in the future.

In some aspects, the list of content repositories a user is associated with is managed by the user storage server or the user agent. Alternatively, the list of content repositories a user is associated with is managed by the distribution engine and may be provided to the user storage servers or user agent via an application programming interface.

As an alternative, the request may be generated by the content repository. In this case, the user may be prompted to specify a user storage system in which the content that should be published is stored. The generated interface may be similar to the above described interfaces for selecting a content repository. Similarly, the list of user storage servers associated with a user may be stored by the content repository or may be received from the distribution engine 126 via an application programming interface. Once, a user storage system has been identified and accessed, the interface may present a list or browser through which a user may select the content to publish. The interface may limit the content that is listed to the types of content that can be published to the content repository (e.g., some content repositories may be limited to notes files, documents, or presentations).

At operation 404, a temporary copy of the content is created in some aspects. The temporary copy of the content may be created in the user storage server that stores the content. Alternatively, the temporary copy of the content may be made in a location controlled by the distribution engine 126.

At operation 406, the temporary copy of the content is prepared for publishing. For example, some aspects remove version histories associated with the content, identifiable author information, and user highlights or comments. Additionally, some aspects collapse revisions into a final or up-to-date version of the content. If the content is distributed across multiple files or multiple directories, the files may be combined into a single package file. Additionally, the content may be compressed to lower the data transfer requirements.

As an alternative to operations 404 and 406, some aspects request a copy of the content from the user storage server that is prepared for publication (e.g., through an application programming interface provided by the user storage server). In these aspects, the user storage server may perform operations similar to those described with respect to operation 404 and 406 rather than the distribution engine 126.

At operation 408, the prepared copy of the content is moved to the publication location. For example, the prepared copy of the content may be moved from the user storage server to the content repository. In some aspects, the prepared copy of the content passes through the distribution services server 108. Alternatively, the prepared copy of the content is copied directly to the content repository (e.g., the distribution engine 126 may call an application programming interface on the user storage server or content repository to trigger the move).

If the content was packaged or compressed before being moved, the content may be unpacked or decompressed once transferred to the content repository. Additionally, if multiple files were packaged together, the original organizational structure and metadata associated with those files may be restored within the content repository.

For example, a notebook from a notes management application that is being published may have several sections that are stored as separate files. The packaging process may combine those several sections into a single file for transferring to the content repository. Once received at the content repository, the separate files for each section may be extracted into the original organization structure of the notebook. Thereafter, the notes management application will be able to interact with the content in the same manner as before it the content was published.

Alternatively or additionally, the content repository 106 may retain the packaged content. The packaged content can then be used for making personal copies of the content.

At operation 410, previews and metadata are generated from the published content. The previews and metadata may be used in directories that make the content available to others. The previews may include short snippets of the content that can be used on other sites such as social media sites. The metadata may include information about the content as well as links to the content. In some aspects, the previews and metadata are generated via a call to an application programming interface provided by the content repository 106 (e.g., by the syndication engine 124).

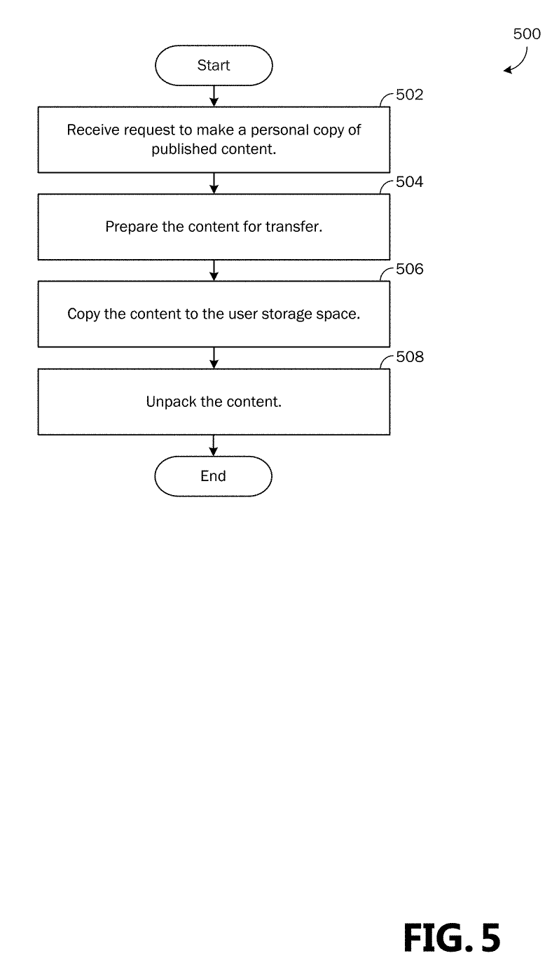

FIG. 5 illustrates a method 500 for making a personal copy of published content. As an example, the method 500 may be executed by a component of an exemplary system such as the system 100. For example, the method 500 may be performed by the distribution engine 126. In examples, the method 500 may be executed on a device comprising at least one processor configured to store and execute operations, programs, or instructions.

At operation 502, a retrieve request is received to make a personal copy of published content. Operation 502 may be similar to the previously described operation 210.

In some aspects, the request is received through a user interface generated by a user storage system or user agent. For example, the request may be generated by a user selecting a link in web page displayed by a user agent. As another example, the request may be generated by a menu option, button, or another user interface element that is displayed when a user is viewing the published content or viewing a listing of published content available in the content repository 106. The user interface may then prompt the user to identify a user storage server to which the content is to be published. Prompting the user to identify a user storage server may be similar to the previously described options for prompting the user to identify a content repository in operation 402 (illustrated and described with respect to at least FIG. 4).

The user may also be prompted to provide authentication credentials for the identified user storage space. Alternatively, the distribution engine may access credentials that have been previously cached for the user.

Additionally, the user may be prompted to specify a location within a personal data store into which the content should be copied. For example, the user may specify the location using a directory browser interface or selecting from a drop-down list of favorite locations.

At operation 504, the content is prepared for transfer to the user storage space. In some aspects, if the content comprises multiple files, the multiple files are packaged into a single file. Additionally, the content may be compressed. Packaging the content for transfer may be performed by the distribution engine 126 (e.g., on a temporary copy of the content) or may be performed via an application programming interface provided by the content repository 106.

Alternatively, in some aspects, the content is stored by the content repository 106 in a format that is already packaged for transfer. For example, the content repository may store both a copy of the content that is available for interaction and a copy that is packaged for transferring.

At operation 506, the content is copied to the specified location in the personal data store on the user storage server. In some aspects, the distribution engine 126 authenticates with the user storage space using the user's authentication credentials. Alternatively, the distribution engine 126 may authenticate separately from the user and may be given access to copy files into the user's personal date store (e.g., the user has previously granted the distribution engine write permission to the personal data store).

At operation 508, the content is unpacked if it was previously packaged for transferring. Thereafter, the personal copy of the content is separate from the published copy and can be modified without regard to the published copy. After unpacking, the content can be accessed through a user agent. The personal copy of the content is independently editable from the published content—that is, the user can modify or annotate the personal copy of the content freely without impact to or being impacted by the published copy. The personal copy of the content is unassociated not typically synchronized with the published content (e.g., the user's changes remain local to the user's copy of the content).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

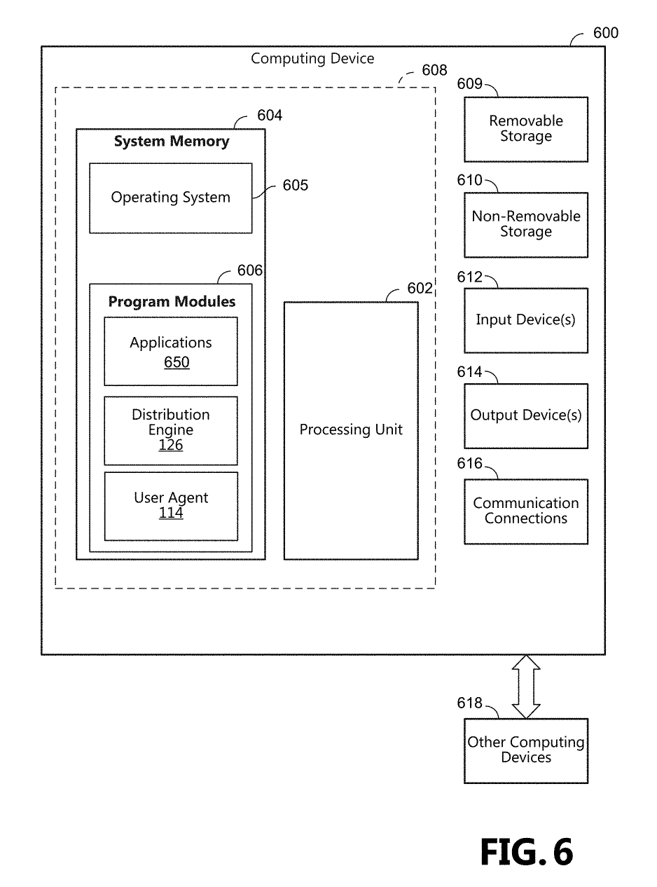

FIGS. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure may be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes the user agent 114 or the distribution engine 126. The operating system 605, for example, is suitable for controlling the operation of the computing device 600. Furthermore, aspects are practiced in conjunction with a graphics library, other operating systems, or any other application program, and are not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., user agent 114, distribution engine 126) perform processes including, but not limited to, one or more of the operations of the methods 200, 400, and 500 illustrated in FIGS. 2, 4, and 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

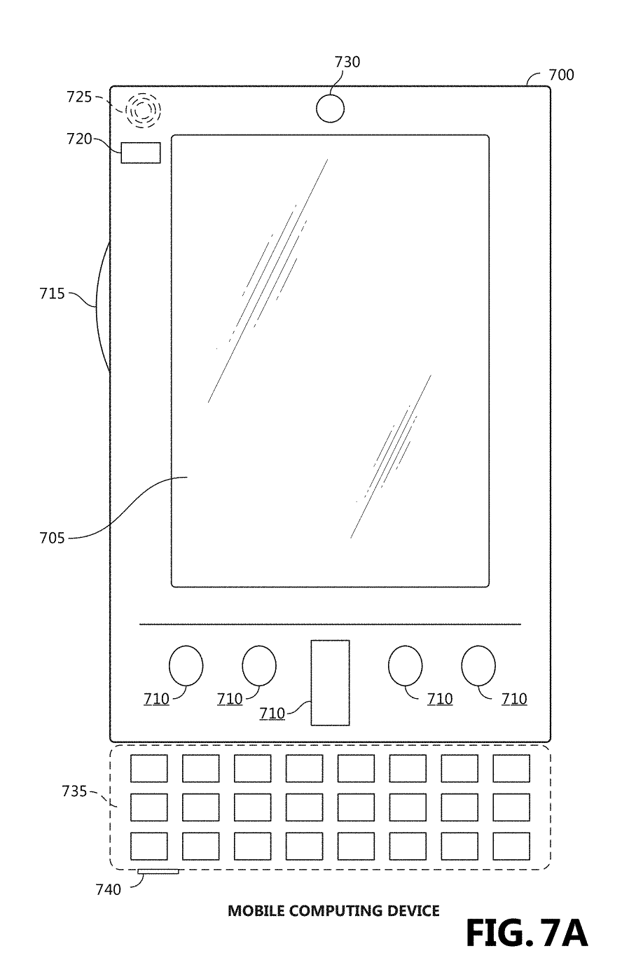

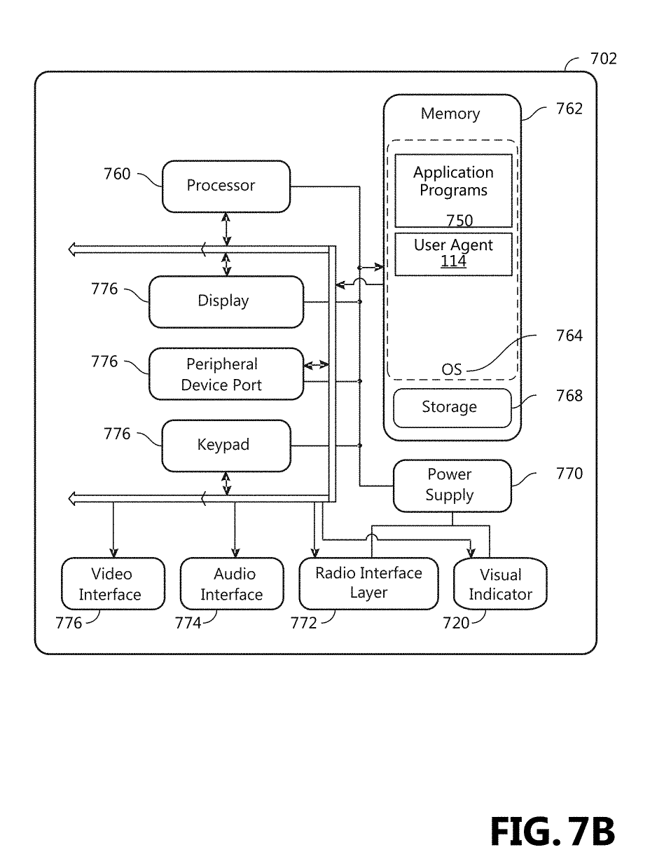

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or fewer input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the user agent 114 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 are stored locally on the mobile computing device 700, as described above. According to another aspect, the data are stored on any number of storage media that are accessible by the device via the radio 772 or via a wired connection between the mobile computing device 700 and a separate computing device associated with the mobile computing device 700, for example, a server computer in a distributed computing network, such as the Internet. As should be appreciated such data/information are accessible via the mobile computing device 700 via the radio 772 or via a distributed computing network. Similarly, according to an aspect, such data/information are readily transferred between computing devices for storage and use according to well-known data/information transfer and storage means, including electronic mail and collaborative data/information sharing systems.

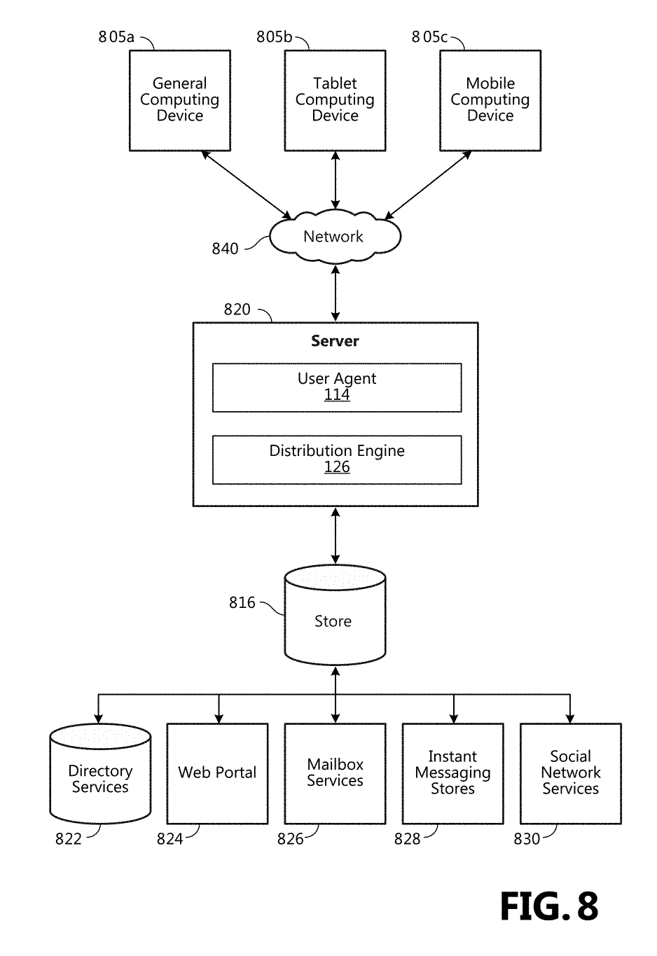

FIG. 8 illustrates one example of the architecture of a system for server-to-server content distribution as described above. Content developed, interacted with, or edited in association with the user agent 114 is enabled to be stored in different communication channels or other storage types. For example, various documents may be stored using a directory service 822, a web portal 824, a mailbox service 826, an instant messaging store 828, or a social networking site 830. The user agent 114 is operative to use any of these types of systems or the like for server-to-server content distribution, as described herein. According to an aspect, a server 820 provides the user agent 114 or the distribution engine 126 to clients 805a,b,c. As one example, the server 820 is a web server providing the user agent 114 or the distribution engine 126 over the web. The server 820 provides the user agent 114 or the distribution engine 126 over the web to clients 805 through a network 840. By way of example, the client computing device is implemented and embodied in a personal computer 805a, a tablet computing device 805b or a mobile computing device 805c (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for distributing content comprising:
at least one processor; and
memory, operatively connected to the at least one processor and storing instructions for an application programming interface that includes a publish command and a retrieve command, wherein the publish command causes the at least one processing device to generate a published copy of a specified first content stored in a first personal data store in a content repository, and the retrieve command causes the at least one processing device to generate a personal copy of a specified second content stored in the content repository in a second personal data store.

2. The system of claim 1, wherein the first personal data store is provided by a first user storage server and the second personal data store is provided by a second user storage server.

3. The system of claim 1, wherein the system further comprises the content repository.

4. The system of claim 1, wherein the personal copy of the second content is independently editable from the second content.

5. The system of claim 1, wherein the first content comprises a plurality of files organized to provide the first content.

6. The system of claim 5, wherein the first content is a notebook, comprising a plurality of notes sections stored in separate files and a table of contents file that is associated with the notes sections.

7. The system of claim 1, wherein the publish command further causes the at least one processing device to:
prepare the first content for publication;
combine a plurality of files associated with the first content into a package;
copy the package to the content repository; and
extract the plurality of files from the package on the content repository.

8. The system of claim 7, wherein the package is compressed before being copied to the content repository.

9. The system of claim 7, wherein the publish command prepares the first content for publication by causing the at least one processing device to:
remove version histories associated with the first content;
remove author-identifiable metadata from the first content;
remove user highlights and comments from the first content; and
merge revisions into a current version of the first content.

10. The system of claim 1, wherein the publish command further causes the processing device to generate previews of the first content, the previews being usable for sharing the content on third-party sites.

11. The system of claim 1, wherein the retrieve command further causes the processing device to:
combine a plurality of files associated with the second content into a package;
copy the package to the second personal data store; and
extract the plurality of files from the package on the second personal data store.

12. A method for server-to-server content distribution, the method comprising:
receiving a publish request to publish content, the content being stored on a user storage server in a personal data store;
preparing the content for publication; and
moving the prepared content to a content repository.

13. The method of claim 12, wherein the publish request identifies the personal data store and the content.

14. The method of claim 13, wherein the publish request further comprises authentication credentials for the personal data store.

15. The method of claim 12, further comprising:
retrieving authentication credentials for the personal data store from a cache.

16. The method of claim 12, wherein preparing the content for publication comprises:
removing version histories associated with the content;
removing author-identifiable metadata from the content;
removing user highlights and comments from the content; and
merging revisions into a current version of the content.

17. The method of claim 12, wherein preparing the content for publication comprises requesting the user storage server prepare the content for publication, and wherein moving the prepared content to the content repository comprises requesting the user storage server directly transfer the prepared content to the content repository.

18. The method of claim 12, further comprising:
receiving a request to make a personal copy of published content stored in the content repository; and
making a copy of the published content in a personal data store in a user storage server, wherein the copy is independently editable of the published content.

19. The method of claim 18, wherein making a copy of the published content comprises causing the user storage server to access the published content in the content repository directly to make a copy of the published content.

20. A method for server-to-server content distribution, the method comprising:
receiving a publish request to publish notebook content comprising a plurality of notes sections stored in separate files and a table of contents file that is associated with the notes sections, the notebook content being stored on a user storage server in a personal data store;
preparing the notebook content for publication by combine the plurality of notes sections and the table of contents file into a package;
moving the package to a content repository and extracting the package to generate published content;
receiving a request to make a personal copy of the published content; and
making a copy of the published content in a personal data store in a user storage server, wherein the copy is independently editable of the published content.
